(19) United States
(12) Patent Application Publication
(10) Pub. No.: US 2020/0082167 A1
(43) Pub. Date: Mar. 12, 2020

(54) SYSTEM AND METHOD FOR TRASH-DETECTION AND MANAGEMENT

(71) Applicants: Ben Shalom, San Diego, CA (US); Adam Todd Geitgey, San Diego, CA (US)

(72) Inventors: Ben Shalom, San Diego, CA (US); Adam Todd Geitgey, San Diego, CA (US)

(21) Appl. No.: 16/125,136

(22) Filed: Sep. 7, 2018

(51) Int. Cl. G06K 9/00; G06N 3/08; G06N 5/04; G06T 7/73

(52) U.S. Cl. CPC G06K 9/00536; G06N 3/08; G06N 5/046; G06T 2207/20084; G06T 7/73; G06K 9/00201; G06K 9/00523

(57) ABSTRACT

A system and process for trash-can management. The process uses digital images to extract trash-cans from the images and a classifier to determine the trash-cans state. The process can include responses to trash-cans that need servicing. A neural network machine learning algorithm is used to identify trash-cans in the image. Neural networks classifiers are used to classify the state of the identified a trash-cans. The neural networks are trained with images containing trash-cans and the surrounding area that have trash and do not have trash to determine a binary state. Trash-cans identified with a low-confidence level can be used to retrain the neural networks. The process can include the management of the trash-can by generating report, maps, notifications, collection routes, or assigning workers.

### CROSS REFERENCE TO OTHER APPLICATIONS

This application claims priority under 35 U.S.C. § 119(e) of the co-pending U.S. provisional patent application Ser. No. 62/555,341 filed on Sep. 7, 2017 entitled “SYSTEM AND DEVICE FOR TRASH MANAGEMENT.” The provisional patent application Ser. No. 62/555,341 filed on Sep. 7, 2017 entitled “SYSTEM AND DEVICE FOR TRASH MANAGEMENT” is hereby incorporated by reference.

### FIELD OF THE INVENTION

The invention relates to systems and methods that uses digital image video frame generated by a digital camera or video to remotely detect the state of trash-cans, and utilizing advance processing techniques, recognize an object (trash-can) and the state of the object (full or not full). Advance processing algorithms are trained for the processing system to identify trash-cans and their state. Further, the invention relates to the management of the trash-cans.

### BACKGROUND OF THE INVENTION

In the past, public and private trash receptacles were manually managed often emptied on a fixed schedule. Often, a fixed schedule often would mean that the trash receptacles would be serviced more often than needed or overflow causing trash to enter the surrounding environment. What is needed is an automated means for monitoring and detecting when a trash-can needs service.

### BRIEF DESCRIPTION OF THE DRAWINGS

FIG. 1A, 1B—Block diagram of the process for trash-can detection, classification and management.

FIG. 2—System block diagram of a system for trash-can management.

### SUMMARY OF THE INVENTION

In one aspect of the invention provides a system for the management of trash-cans. The system is comprised of a digital camera or video camera for taking a digital image or digital video frame. A first processing system identifies and extracts the part of the image that contains trash-cans. Using a neural network, a training set is used to train the neural network to identify the trash-cans within a training set of digital images. The identified trash-can is passed to a second processing system. Multiple neural network machine learning algorithms, previously trained, classify the trash cans as being full or not being full.

The digital camera can be stationary or movable. Stationary cameras can be mounted on buildings and the movable camera can be coupled to a vehicle. Additionally, the camera or can rotate and change inclination. The camera can add information to the digital image including but not limited to GPS location, camera inclination and orientation, and date and time.

A first processing system implements object recognition algorithms to detect trash-cans within a digital image. The trash-can detection algorithms can include but are not limited to a histogram of oriented gradients detector using Max margin Object Detection machine learning algorithm, a Mask R-CNN machine learning algorithm, a convolutional neural network feature extractor combined with max margin object detection machine learning algorithm, and harr feature-based cascade classifier machine learning algorithm. Preferably, both a histogram of oriented gradients detector using Max Margin Object Detection machine learning algorithm and a Mask R-CNN machine learning algorithm are both used in the first processing system.

The trash-can detection machine learning algorithms are trained with a training set of images that includes city streets with trash-cans where the trash-can boundaries are specified for the algorithm training. The trash-cans can be specified by either box around the trash-can or the outline of the trash-can. The box or outline can be generated by a human.

The system includes a second pipelined processing module, the classifier module. The classifier module includes two trained neural net classifier machine algorithms to classify the trash-can images extracted by the trash-can detector module. The trained neural net machine algorithms can be selected from AlexNet, GoogLeNet, VGG-16, VGG-19, ResNet-18, ResNet-34, ResNet-50, ResNet-101, ResNet-152, Inception v3, and Inception v4 machine algorithms.

A first neural net is trained using a standardized “Image Net Object” recognition challenge dataset. The second trained neural network is trained with images containing one or more trash-cans and images that do not contain trash-cans.

The output of the classifier can be a binary output “TRASH”, “NOT TRASH”. The result of the classification can be stored in a database and utilized by a trash-can management process or module. In this module, the state of the trash-cans can be processed to generate a report, a map overlaid with the state of the trash-cans, notifications, worker assignments, a collection route, or a combination thereof. Additionally, an API (application programming interface) can be provided by the management process or module for obtaining the status of one or more trash-cans.

### DETAILED DESCRIPTION OF THE INVENTION

Certain specific details are set forth in the following description and figures to provide a thorough understanding of various embodiments of the inventions. Certain well known details often associated with computing and software technology are not described in the following disclosure for the sake of clarity. Furthermore, those of ordinary skill in the relevant art will understand that they can practice other embodiments of the disclosed subject matter without one or more of the details described below. While various methods are described with reference to steps and sequences in the following disclosure, the description as such is for providing a clear implementation of embodiments of the disclosed subject matter, and the steps and sequences of steps should not be taken as required to practice the invention.

It should be understood that the various techniques described herein may be implemented in connection with hardware or software or, where appropriate, with a combination of both. Thus, the methods and apparatus disclosed herein, or certain aspects or portions thereof, may take the form of program code (i.e., instructions) embodied in tangible media, such as floppy diskettes, CD-ROMs, hard drives, or any other machine-readable storage media that may be loaded into and executed by a machine, such as a computer. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosed subject matter, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

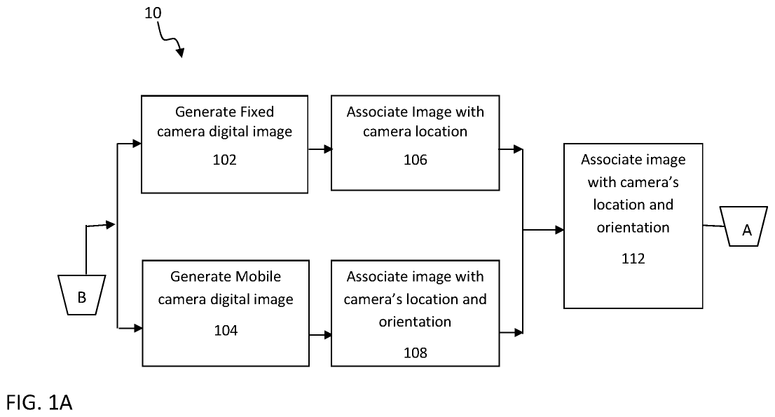

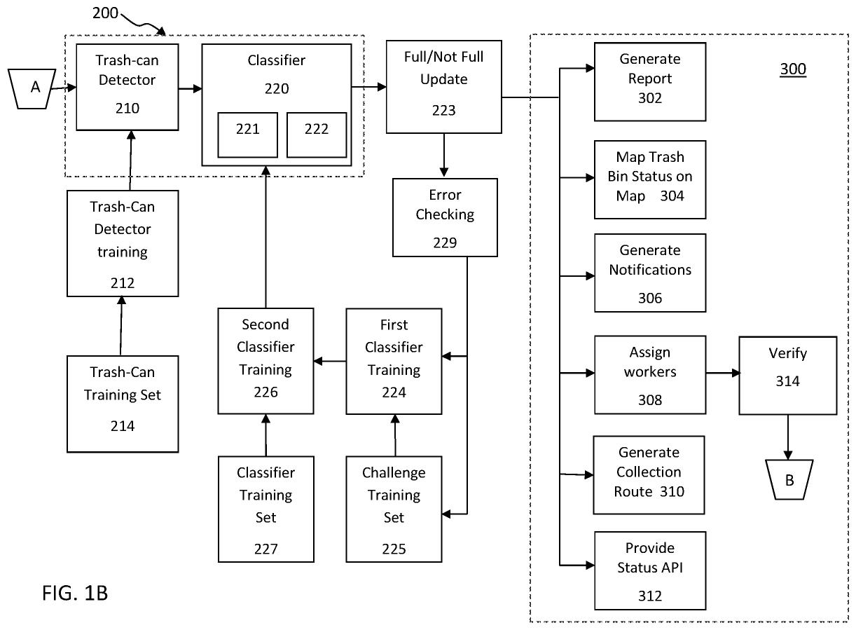

Referring to FIGS. 1A and 1B, a process diagram of a trash management system is shown and described. The process includes generating images, image processing techniques to identify the trash-cans within an image, deep neural networks to classify the images, and classification machine learning algorithm to determine the state of a trash-can state (full or not full), and generating a response to manage the trash-can state. The process includes training the system for detecting trash-cans and classifying the state of the trash-cans. As used in this specification, digital image and digital video frame are interchangeable. The use of the term digital image includes digital video frame.

Digital cameras generate either a fixed digital image 102 or a mobile camera image 104. The fixed or mobile camera images 102, 104 can include a video stream of digital image frames. The resolution of the digital image needs to be sufficient to support the training of the neural networks and classification algorithms. A person skilled in the art of image processing and training neural networks would be able to determine the required image resolution without undue experimentation.

The mobile camera or video cameras can have their orientation changed, including inclination and direction. For example, the mobile camera 104 could be mounted on a vehicle include but not limited to a drone, bus, auto, and subway car. Additionally, either a mobile or fixed camera has a fixed or changeable camera inclination and direction. Both the location of the camera, its inclination, and the direction that the camera is pointing can be required to uniquely identify a trash-can. Further, a time stamp of the digital image can be used in associating a digital image with a specific trash-can.

The fixed or mobile digital images FIG. 1-102, 104 can include time, location, and direction and inclination orientation information. The location information can be GPS coordinates of the camera or any other unique location information or references including but not limited to unique labels viewable within the digital images. The labels include but are not limited to numbers, bar codes, and QR codes. In a processing step, an association of the digital image and the location and orientation information 106, 108 is made.

In a processing step 112 the digital image and associated location and orientation information is associated with a known trash-can in a resource database 628-FIG. 3. If the association cannot be made, this information can be flagged to indicate that a trash-can is missing or has been moved. The system can schedule to replace the missing trash-can or incorporating the missing status into a report.

In a next processing step, an image recognition pipeline 200, processes the digital image(s) to identify the portions of the digital image including any trash-cans, and determine the state of a trash-can otherwise known as classifying. This processing can be performed by special purpose hardware and/or software. The software can run on a general purpose computer and can utilized other processing accelerators including but not limited to graphics processors, and digital signal processors. As used in this specification, digital image and digital video frame are interchangeable. Special purpose hardware can include custom hardware or neural network processing semiconductor chips.

The input to the image recognition and classification pipeline 200 can include but is not limited to a digital video stream or still digital images from a camera (including building-mounted or vehicle-mounted cameras). As shown in FIG. 1B, the pipeline 200 receives the digital image data after the location and orientation information is associated with the image data and is associated with trash-can in a resource database 112.

The digital images are first processed by a trash-can detector 210 stage of the pipeline 200. In this first pipeline stage, the trash-can detector process 210 detects and locates any trash-cans in the digital image. The final output of the trash-can detector step 210 is preferably a digital image of the trash-can pixels clipped from the digital image. Additionally, the area above and around the trash can is included in the clipped image. Alternatively, the location of each trash-can within the image could be determine and passed to the classifier stage in the pipeline 220.

The trash-can detector process 210 includes an object recognition processing algorithm to locate trash-cans in each digital video frame or digital still image. The object recognition process 210 incorporates machine learning to locate one or more trash-cans within an image. The preferred embodiment uses both a Max-Margin Object Detection (MMOD) machine learning algorithm and a Mask R-CNN machine learning algorithm, however other object detection algorithms can be used in its place. Other object recognition machine algorithms that can be utilized for trash-can detection includes but is not limited to:
Histogram of Oriented Gradients (HOG) detector using Max Margin Object Detection (MMOD) as described in “Max-Margin Object Detection” by Davis E. King;
A convolutional neural network feature extractor combined with Max Margin Object Detection (MMOD) as described in “Max-Margin Object Detection” by Davis E. King;
Harr Feature-based Cascade Classifier, as described in “Rapid Object Detection using a Boosted Cascade of Simple Features” by Paul Viola and Michael Jones.

One skilled in the art of programming object recognition algorithms would be able to select and implement an object recognition algorithm for trash-can detection.

The trash-can detector process 210 is initially trained before use operationally. Training is provided with a trash-can training set 214. A training process 212 configures the trash-can detector machine learning algorithm 210 through training with a set of images 214 containing trash-cans. The training module 212, which executes the machine learning neural network, is fed images of city streets with the trash-can locations annotated as boxes drawn by human or the outline of a trash-can. From this training, the trash-can detector training 212 the trash-can detector machine algorithm 210 learns to separate each image into areas that do and do not contain trash-cans. Once the trash-can detector training 212 is completed, the trained configuration for the trash-can detector process 210 is enabled to process digital images. The output of this process 210 is a bounding box of the location of each trash-can within the digital image(s) and a confidence score and image pixels above the trash-can and around the trash-can.

When a trash-can is located within the digital image by the trash-can detector process 210 of the pipeline, the trash-can image (including the area above the top of the trash-can or around it) is clipped out of the original digital image. The smaller trash-can image is then sent to a next step in the pipeline, the classifier process 220.

Classifier Process

The classifier process 220 receives the smaller trash-can digital image and the pixel data surrounding the trash-can image. The output of the classifier 220 is either “TRASH” or “NOT TRASH.” However, additional image classification states are contemplated including but not limited to an overflowing state.

This classifier process 220 incorporates one or more neural networks to determine each trash-can's state, overflowing with trash or not. As shown in FIG. 1B, the image classification process 220 includes a first neural network classification machine 221 and a second deep neural network classification machine 222. In the preferred embodiment, classifier process 221, 222 uses a VGG16 deep neural network design, but any state-of-the-art deep neural image classification model can be used. Other Suitable deep neural image classification models include, but are not limited to:
AlexNet, as described in “ImageNet Classification with Deep Convolutional Neural Networks”, by Alex Krizhevsky, et al;
GoogLeNet, as described in “Going Deeper with Convolutions” by Christian Szegedy, et al;
VGG-16 or VGG-19, as described in “Very Deep Convolutional Networks for Large-Scale Image Recognition” by Karen Simonyan and Andrew Zisserman;
ResNet-18, ResNet-34, ResNet-50, ResNet-101 or ResNet-152, as described in “Deep Residual Learning for Image Recognition”, by Kaiming He, et al;
Inception v3 as described in “Rethinking the Inception Architecture for Computer Vision” by Christian Szegedy et al;
Inception v4 or Inception-ResNet, as described in “Inception-v4, Inception-ResNet and the Impact of Residual Connections on Learning” by Christian Szegedy et al;
XCeption, as described in “Xception: Deep Learning with Depthwise Separable Convolutions” by Francois Chollet;

To reduce the amount of training data required to train the classification process 220, “TRASH”/“NOT TRASH”, the image classifier neural network 220 is trained in a two-stage process. First, in a training process 224 the first neural network classification machine algorithm 221 is trained to recognize all the images in the ImageNet object recognition challenge dataset 225. This is a standard benchmark used to train image classification systems.

Once the first neural network classification machine algorithm 221 is trained to recognize the challenge dataset 225, the top prediction layer of the first neural network classification machine algorithm 221 is removed. This causes the first neural network classification machine algorithm 221 to output image feature vectors instead of final classification scores.

In the second training process 226, images of trash-cans 227 that do and do not contain trash are fed through the first neural network classification machine algorithm 221 to create training features representing those two classes or states. Finally, those training features are used in the second classifier training process 226 to train a second neural network classification machine 222 to detect if a given image feature vector contains trash or not. This second neural network classification machine algorithm 222 is made of up of a densely-connected layer of neurons, a dropout layer and another densely connected layer that makes a binary prediction state of “TRASH” vs “NOT TRASH”, along with a confidence score.

In a post classification processing step 223, each trash-can image identified by the image recognizer pipeline 200 is stored in a database along with the classified state and confidence level of the classification. The identified trash-can can be associated with known trash-cans or if the locations are unpredictable, an entry input into the database. The database can include the location for where the image was taken, the camera inclination and the camera pointing direction, time and date, the full image from which the picture was taken, the location of the trash-can within the image and the state of the trash-can “TRASH” or “NOT TRASH”, and the confidence indicator of the state determination.

The process 10 can include an optional error checking step 229. In this step 229, trash-cans that were identified with a low confidence level, are made available to a human operator to review. An identifier can be used to show the image location of the trash-can. If the operator decides that the image was incorrectly classified, then this image can be input into the classifier training sequence 224 and 226 to refine the classification sequence. Alternatively, the incorrectly classified image can be added to either the challenge training set 225, the classifier training set 227, or both for later retraining of the classifier neural nets 221, 222. Alternatively, the process can be automated where images with a low confidence level are used in retraining the classifier 220 or loaded into the classifier training set 227 or challenge training set 225.

The process 10 can include post classification processing by the trash-can management process 300. A database or the trash-can state information is processed by the trash-can. The trash-can state information can generate reports on which trash-cans need service. A map can be generated with an overlay of which trach-cans need servicing. Other responses include generating notifications that include but are not limited to texts or emails. A worker could can be assigned to service a trash-can. Additionally, a collection route can be generated or an API can be provided for other software programs to access the trash-can state information.

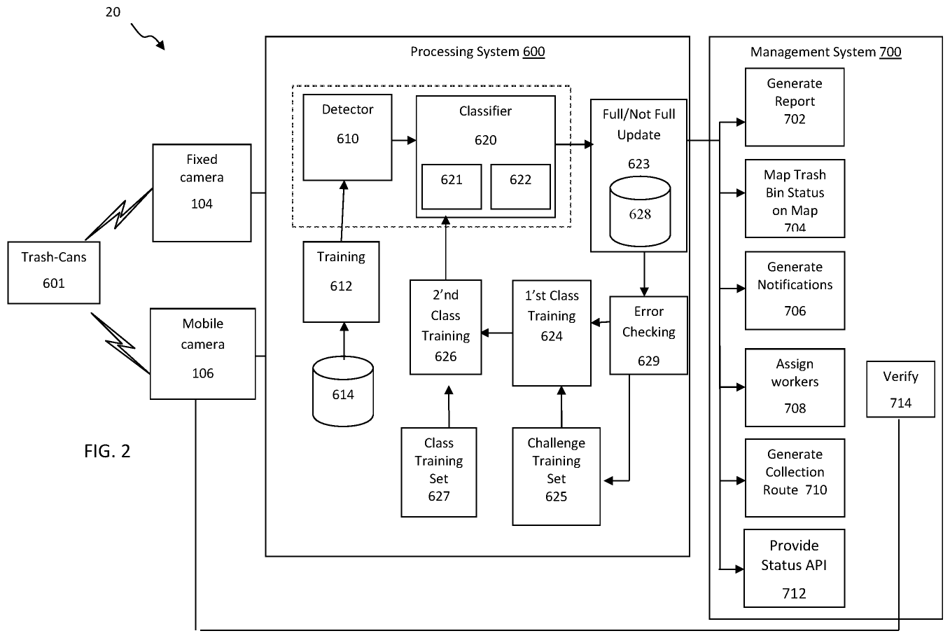

Referring to FIG. 2, a trash-can detection and management system 20 block diagram is shown and described. The system includes trash-cans 601, either a fixed camera 104 or mobile camera 106 or both, A processing system 600 for identifying trash-can and classifying them, and a management system 700 that processes the classified trash-cans 601.

The cameras 2014, 106 generate digital images or video frames that are processed by the processing system 600 and generated a classification of each detected trash-bin 601 in the system.

The trash-can detector 610, the training 612, and the training set 614 function as described above for the processing steps 210, 212, and 214. The classifier module 620, 621, 622, also perform the same processing as described above for the 220, 221, 222 module. The classifier module 220 requires training which can be performed by the 1'st classifier training module 624, and the 2'nd classifier training module 626. These modules operate as described above for 224 and 226 processes. The classifier training modules 625, and 627 contain training images as specified above for the training set 225, and 227. These modules can store the training images on disk drives or other permanent storage media.

The Full/Not full Update module 623 can be a program or sub-program running on a server or dedicated computer. This module 623 can manage the status of all know trash-can and update their status as new trash-can classifications are received. The state of the trash-can module can be stored on a resource database 628.

The system 20 can include an error checking software module 629. The module 629 can check the resource database 628 for status updates with low confidence levels. The associated image for the low confidence can be displayed to a human operator. The operator can then make a manual assessment of whether the trash-can's state is correct. If not, then the associated image can be used to expand the challenge training set 625 or the class training set 627.

The system 20 can include a trash-can management module 700. The management system 700 will process updates to the resource database 628 and either generate a report 702, map the status of the trash-cans on a displayable graphics map 704, generate notification 706, generate a collection route 710, or provide access to this status information through an API 712. The management module 700 can include a verification module 714. This module 714 will task the system 20 to verify that a trash-can 601 that needs service is serviced. The module 714 will have the system task the fixed of mobile camera 104, 106 to take a picture, process it through the processing system 600, and verify that the trash-can was service.

All modules mentioned above can be, but do not have to be executed on general purpose servers, custom computers, with or without special hardware. Special hardware can include neural network processors. The modules can be written in any appropriate programming language and utilize common operating systems.

The following description is provided as an enabling teaching of several embodiments of the inventions disclosed. Those skilled in the relevant art will recognize that many changes can be made to the embodiments described, while still attaining the beneficial results of the present inventions. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

What is claimed:

1. A trash-can management system comprising:
a digital camera configured to generate a digital image;
a first digital processing module configured to extract a trash-can image from the digital image; and
a second digital processing module configured to classify the trash-can image and configured to generate a trash-can state indication.

2. The system of claim 1, wherein the digital camera is movable and configured to generate a digital image from a configurable location indication and direction.

3. The system of claim 1, wherein first digital processing module is configured to extract the trash-can image using a machine learning algorithm selected from the group consisting of a histogram of oriented gradients detector using Max Margin Object Detection machine learning algorithm and a Mask R-CNN machine learning algorithm.

4. The system of claim 1, wherein first digital processing module is configured to extract the trash-can image using a machine learning algorithm selected from the group consisting of a histogram of oriented gradients detector using max margin object detection machine learning algorithm, a Mask R-CNN machine learning algorithm, a convolutional neural network feature extractor combined with max margin object detection machine learning algorithm, and harr feature-based cascade classifier machine learning algorithm.

5. The system of claim 3, wherein the machine learning algorithm is trained with an extraction training set, wherein the extraction training set includes city streets with trash-cans including specification of the trash-cans boundaries within the training set.

6. The system of claim 1, wherein the second processing module includes a first trained neural net classifier machine algorithm to classify the trash-can image, wherein the first neural net classifier machine algorithm is selected from the group consisting of AlexNet, GoogLeNet, VGG-16, VGG-19, ResNet-18, ResNet-34, ResNet-50, ResNet-101, ResNet-152, Inception v3, and Inception v4.

7. The system of claim 6, wherein the second processing module further includes a second trained neural net machine algorithm, wherein the first trained neural net classifier machine algorithm includes a top prediction layer, wherein when the top prediction layer is disabled the first trained neural net classifier machine algorithm outputs image feature vectors, and wherein the image feature vectors are the input to train the second neural net classifier machine algorithm.

8. The system of claim 7, wherein the first trained neural net classifier is first trained with a first classifier training set, wherein the second trained neural net machine algorithm is trained with a second classifier training set, wherein the first classifier training set is Image Net object recognition challenge dataset, and wherein the second classifier training set is input into the first trained neural net classifier and contains digital images of trash-cans that contain trash and digital images of trash-cans with and without trash, and wherein the image feature vectors generated by the first trained neural net classifier are used to train the second neural net, wherein the second trained neural net machine algorithm generates the trash-can state indication.

9. A method of trash-can management comprising:
receiving a digital image;
extracting a trash-can image from the digital image; and
classifying the trash-can image, wherein the classifying generates a trash-can state indication.

10. A method of claim 9, wherein the digital image is generated from a movable source, and wherein the digital image includes a location indication and orientation information.

11. The method of claim 9, wherein the extracting is selected from the group consisting of histogram of oriented gradients detector using Max Margin Object Detection machine learning algorithm and a Mask R-CNN machine learning algorithm.

12. The method of claim 9, wherein the extracting is selected from the group consisting of histogram of oriented gradients detector using Max Margin Object Detection machine learning algorithm, Mask R-CNN machine learning algorithm a convolutional neural network feature extractor combined with max margin object detection machine learning algorithm, and a Harr feature-based cascade classifier machine learning algorithm.

13. The method of claim 11, wherein the extracting machine learning algorithm is trained with a extraction training set, wherein the extraction training set includes city streets with trash-cans including specification of the trash-cans boundaries within the training set.

14. The method of claim 9, wherein the classifying uses a first trained neural net classifier machine algorithm selected from the group consisting of AlexNet, GoogLeNet, VGG-16, VGG-19, ResNet-18, ResNet-34, ResNet-50, ResNet-101, ResNet-152, Inception v3, and Inception v4.

15. The method of claim 13, further including a second trained neural net machine algorithm, wherein the first trained neural net classifier machine algorithm includes a top prediction layer, wherein when the top prediction layer is disabled the first trained neural net classifier machine algorithm outputs image feature vectors, and wherein the image feature vectors are the input to train the second neural net machine algorithm.

16. The method of claim 14, wherein the first trained neural net classifier machine algorithm is first trained with a first classifier training set, wherein the second trained neural net machine algorithm is trained with a second classifier training set, wherein the first classifier training set is the Image Net object recognition challenge dataset, and wherein the second classifier training set is input into the first trained neural net classifier machine algorithm and includes digital images of trash-cans with trash and digital images of trash-cans without trash, and wherein the image feature vectors generated by the first trained neural net classifier are used to train the second trained neural net machine algorithm, wherein the second neural net generates a trash-can state indicator.

17. The method of claim 15, wherein the trash-can state indication is trash or no trash.

18. The method of claim 16, further comprising a trash-can management process, wherein the digital image further includes location and orientation information, wherein the trash-can indicator is associated with a known trash-can within a management database using the location information, and wherein the trash-can management process generates a report containing the trash-can state indication associated with the known trash-can, a graphical map with an overlay of the known trash-cans and the associated trash-bin indication, generate notifications other electronic systems or a combination thereof.

19. The method of claim 16, wherein the second trained neural net machine algorithm produces a confidence indicator, wherein when the confidence indicator is below a threshold the trash-can image is checked by a human operator, and wherein the human operator can decide to retrain the second trained neural net machine algorithm with the using the trash-can image.

20. A method of trash-can management comprising:
receiving a digital image, wherein the digital image includes a location indication and orientation information;
extracting a trash-can image from the digital image, wherein the extracting is selected from the group consisting of histogram of oriented gradients detector using Max Margin Object Detection machine learning algorithm and a Mask R-CNN machine learning algorithm, wherein the extracting machine learning algorithm is trained with a extraction training set, wherein the extraction training set includes city streets with trash-cans including specification of the trash-cans boundaries within the training set; and
classifying the trash-can image, wherein the classifying uses a first trained neural net classifier machine algorithm selected from the group consisting of AlexNet, GoogLeNet, VGG-16, VGG-19, ResNet-18, ResNet-34, ResNet-50, ResNet-101, ResNet-152, Inception v3, and Inception v4, further including a second trained neural net machine algorithm, wherein the first trained neural net classifier machine algorithm includes a top prediction layer, wherein when the top prediction layer is disabled the first trained neural net classifier machine algorithm outputs image feature vectors, and wherein the image feature vectors are the input to train the second neural net machine algorithm, wherein the first trained neural net classifier machine algorithm is first trained with a first classifier training set, wherein the second trained neural net machine algorithm is trained with a second classifier training set, wherein the first classifier training set is the Image Net object recognition challenge dataset, and wherein the second classifier training set is input into the first trained neural net classifier machine algorithm and includes digital images of trash-cans with trash and digital images of trash-cans without trash, and wherein the image feature vectors generated by the first trained neural net classifier are used to train the second trained neural net machine algorithm, wherein the second neural net generates a trash-can state indicator, and wherein the classifying generates a trash-can state indication.
